(19) United States
(12) Patent Application Publication
(10) Pub. No.: US 2007/0181797 A1
(43) Pub. Date: Aug. 9, 2007

(54) Mass spectrum analysis device, mass spectrum analysis method, and mass spectrum analysis program

(75) Inventors: Kazuhiko Uchida, Ibaraki (JP); Masami Sato, Ibaraki (JP); Junya Nishiguchi, Tokyo (JP); Shinsuke Yamasaki, Tokyo (JP)

Correspondence Address: SUGHRUE MION, PLLC, 2100 PENNSYLVANIA AVENUE, N.W., SUITE 800, WASHINGTON, DC, 20037, US

(73) Assignees: MCBI, INC., Tsukuba-shi (JP); YAMATAKE CORPORATION, Chiyoda-ku (JP)

(21) Appl. No.: 11/570,211

(22) PCT Filed: Jun. 8, 2005
(86) PCT No.: PCT/JP05/10471

§ 371 Date: Mar. 9, 2007

(30) Foreign Application Priority Data
Jun. 8, 2004 (JP) 2004-170244

(51) Int. Cl. H01J 49/00

(52) U.S. Cl. 250/288

(57) ABSTRACT

There are provided a mass spectrum analysis device, a mass spectrum analysis method, and a mass spectrum analysis program capable of accurately analyzing a mass spectrum.

The mass spectrum device analyzes a mass spectrum measured for a plurality of samples. The mass spectrum device includes peak position detection means 14 for detecting a peak position where the mass spectrum is at its peak, and coincidence degree calculation means 15 for calculating the coincidence degree of peaks according to the number of peak positions detected in a plurality of mass spectra that is contained in a window having a width for a mass number.

### TECHNICAL FIELD

The present invention relates to a device, method, and program for analyzing a mass spectrum measured for samples.

### BACKGROUND ART

Recently, MALDI-TOF-MS (Matrix-Assisted Laser Desorption/Ionization Time-Of-Flight Mass Spectrometry) has come into wide use. The MALDI-TOF-MS performs the mass spectrometric analysis on proteins in blood, for example, to thereby provide the diagnosis of diseases, the biochemical elucidation of precise mechanism of disease development, and so on. Specifically, the mass spectrum of proteins which increase in blood as cancer spreads is measured and analyzed so as to find a pattern for distinguishing between cancer and non-cancer, and make a judgment using the pattern as a reference.

In the MALDI-TOF-MS, the analysis of a peak of a mass spectrum is important. Conventionally, the analysis of a mass spectrum has been carried out by the hands of operators. Specifically, the conventional procedure collects a plurality of samples from each of a normal healthy person and a patient and measures mass spectra for the samples. It then visually overlaps the plurality of mass spectra to extract a characteristic peak which exhibits a difference between the normal healthy person and the patient. However, the human perceptual judgment varies and thus fails to provide highly reproducible analysis. Further, it takes a long time for the analysis. Particularly, if there are a large number of samples, the analysis takes a long time to cause inefficiency and fails to demonstrate high reproducibility.

Further, a data processing device that calculates the area or height of each peak for data of two chromatograms and casts a difference in the calculated area or height into a histogram for each peak is disclosed (Patent Document 1). However, the data processing device operates to compare two chromatograms and therefore it is not suitable for the analysis of mass spectra for various biological samples.

[Patent Document 1]

Japanese Unexamined Patent Application Publication No. 9-210983

### DISCLOSURE OF THE INVENTION

### Problems to be Solved by the Invention

A biological sample, such as blood, which is taken from a living body generally exhibits wide variation in a mass spectrum. Therefore, a comparison of data between a normal healthy person and a patient does not always reveal a significant difference. Due to being a biological sample, the position, height, area and so on of the peaks of a mass spectrum can vary even if the mass spectrum is obtained from the same patient because of an individual difference in living body itself, a change in health condition, and so on. Further, because of the presence of atom isotope and the coexistence of a plurality of biochemical substances, the analysis is complicated. If a mass spectrum is measured with different mass spectrometers, a difference occurs in the mass spectrum due to device settings.

However, such variation factors, if any, are not as critical as causing the mass spectral peak to completely lose its characteristics. Thus, the peak characteristics appear so far forth as patterns of a patient and a normal healthy person can be distinguished by perceptual judgment of a skilled person.

The present invention has been accomplished to solve the above problems and an object of the present invention is thus to provide a mass spectrum analysis device, analysis method, and analysis program capable of accurately analyzing a mass spectrum for samples.

### MEANS FOR SOLVING THE PROBLEMS

According to a first aspect of the present invention, there is provided a mass spectrum analysis device for analyzing mass spectrum measured for a plurality of samples, including peak position detection means (e.g. a peak position detection unit 14 according to an embodiment of the present invention) for detecting a peak position where the mass spectrum is at its peak, and coincidence degree calculation means (e.g. a coincidence degree calculation unit 15 according to an embodiment of the present invention) for calculating a coincidence degree of peaks according to the number of peak positions detected in a plurality of mass spectra that is contained in a window having a width for a mass number. This enables accurate analysis of a mass spectrum.

According to a second aspect of the present invention, there is provided the above-described mass spectrum analysis device wherein weights are assigned to the number of peaks according to a position of the window. This enables accurate analysis of a mass spectrum.

According to a third aspect of the present invention, there is provided the above-described mass spectrum analysis device wherein the plurality of mass spectra are measured for each of two different groups of samples, and the device further includes coincidence degree difference calculation means (e.g. a coincidence degree difference calculation unit 16 according to an embodiment of the present invention) for calculating a difference in coincidence degree between the two different groups. This enables accurate analysis of a mass spectrum.

According to a fourth aspect of the present invention, there is provided a mass spectrum analysis method for analyzing mass spectrum measured for a plurality of samples, including a peak position detection step (e.g. a peak position detection step S102 according to an embodiment of the present invention) for detecting a peak position where the mass spectrum is at its peak, and a coincidence degree calculation step (e.g. a coincidence degree calculation step S103 according to an embodiment of the present invention) for calculating a coincidence degree of peaks according to the number of peak positions detected in a plurality of mass spectra that is contained in a window having a width for a mass number. This enables accurate analysis of a mass spectrum.

According to a fifth aspect of the present invention, there is provided the above-described mass spectrum analysis method wherein weights are assigned to the number of peaks according to a position of the window. This enables accurate analysis of a mass spectrum.

According to a sixth aspect of the present invention, there is provided the above-described mass spectrum analysis method wherein the plurality of mass spectra are measured for each of two different groups of samples, and the method further includes a coincidence degree difference calculation step (e.g. a coincidence degree difference calculation step S105 according to an embodiment of the present invention) for calculating a difference in coincidence degree between the two different groups. This enables accurate analysis of a mass spectrum.

According to a seventh aspect of the present invention, there is provided a mass spectrum analysis program for analyzing mass spectrum measured for a plurality of samples, causing a computer to implement a method including a peak position detection step for detecting a peak position where the mass spectrum is at its peak, and a coincidence degree calculation step for calculating a coincidence degree of peaks according to the number of peak positions detected in a plurality of mass spectra that is contained in a window having a width for a mass number. This enables accurate analysis of a mass spectrum.

According to an eighth aspect of the present invention, there is provided the above-described mass spectrum analysis program wherein weights are assigned to the number of peaks according to a position of the window. This enables accurate analysis of a mass spectrum.

According to a ninth aspect of the present invention, there is provided the above-described mass spectrum analysis program wherein the plurality of mass spectra are measured for each of two different groups of samples, and the method further includes a coincidence degree difference calculation step for calculating a difference in coincidence degree between the two different groups. This enables accurate analysis of a mass spectrum.

### ADVANTAGES OF THE INVENTION

The present invention provides a mass spectrum analysis device, analysis method, and analysis program capable of accurately analyzing a mass spectrum for samples.

### BRIEF DESCRIPTION OF THE DRAWINGS

FIG. 1 is a block diagram schematically showing the structure of a mass spectrum analysis device according to a first embodiment of the present invention;

FIG. 2 is a flowchart showing a process of an analysis method according to the first embodiment of the present invention;

FIG. 3 is a view showing an example of a mass spectrum measured by a measuring device of the present invention;

FIG. 4A is a graph showing a mass spectrum and its peak positions of a normal healthy person group measured by a measuring device of the present invention;

FIG. 4B is a graph showing a mass spectrum and its peak positions of a patient group measured by a measuring device of the present invention;

FIG. 4C is a graph showing mass spectra and its peak positions of a normal healthy person group and a patient group measured by a measuring device of the present invention;

FIG. 5 is a graph showing mass spectra of patients measured by a measuring device of the present invention;

FIG. 6 is a graph showing mass spectra of patients measured by a measuring device of the present invention;

FIG. 7 is a graph showing peak positions and scanning through a window in an analysis method of the present invention;

FIG. 8 is a graph showing a window shape and peak positions in an analysis method of the present invention;

FIG. 9 is a graph showing a coincidence degree and peak positions in samples of patients of the present invention;

FIG. 10 is a graph showing a coincidence degree and peak positions in samples of normal healthy persons in the present invention; and

FIG. 11 is a graph showing a difference in a coincidence degree in an analysis method of the present invention.

### DESCRIPTION OF REFERENCE NUMERALS

10 ANALYSIS DEVICE
11 DATA I/F UNIT
12 INPUT UNIT
13 ANALYSIS UNIT
14 PEAK POSITION DETECTION UNIT
15 COINCIDENCE DEGREE CALCULATION UNIT
16 COINCIDENCE DEGREE DIFFERENCE CALCULATION UNIT
17 DISPLAY UNIT
20 MEASUREMENT DEVICE
51 WINDOW
52 WINDOW SHAPE

### BEST MODES FOR CARRYING OUT THE INVENTION

Embodiments of the present invention are described hereinbelow. The explanation provided hereinbelow merely illustrates exemplary embodiments of the present invention, and the present invention is not limited to the below-described embodiments. The description hereinbelow is appropriately shortened and simplified to clarify the explanation. A person skilled in the art will be able to easily change, add, or modify various elements of the below-described embodiments, without departing from the scope of the present invention. In the figures, the identical reference symbols denote identical structural elements and the redundant explanation thereof is omitted.

In order to compare mass spectra of samples of patients suffering from particular disease and samples of normal healthy persons, the present invention collects biological samples from a plurality of patients and a plurality of normal healthy persons and measures a mass spectrum for each sample. Then, the invention compares the measured mass spectra of the patients and the normal healthy persons to thereby obtain characteristic peaks appearing in the mass spectra. In this embodiment, results of the manual analysis by a skilled person are shown for comparison with results of the analysis according to the present invention.

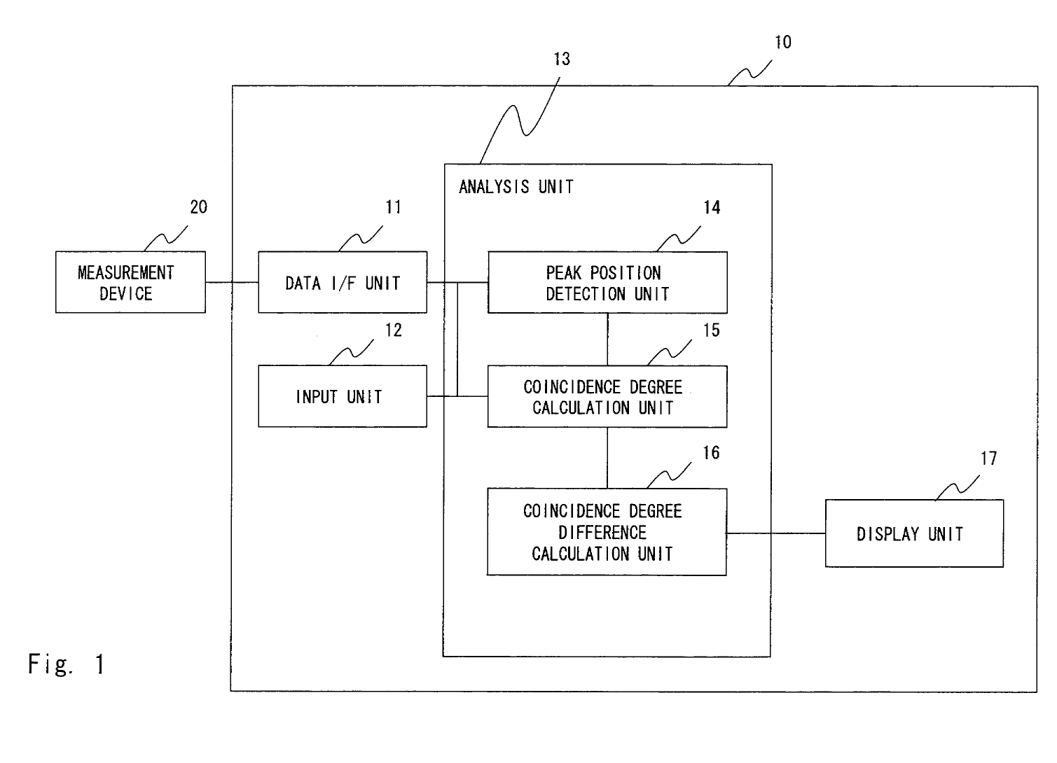

A mass spectrum analysis device according to the present invention is described hereinafter with reference to FIG. 1. FIG. 1 is a block diagram showing the structure of a mass spectrum analysis device according to the present invention. Reference numeral 10 designates an analysis device, 11 designates a data I/F unit, 12 designates an input unit, 13 designates an analysis unit, 14 designates a peak position detection unit, 15 designates a coincidence degree calculation unit, 16 designates a coincidence degree difference calculation unit, 17 designates a display unit, and 20 designates a measurement device.

The analysis device 10 according to the present invention may be a processing unit such as a personal computer, for example, and analyzes the mass spectrum which is measured by the measurement device 20. The measurement device 20 may include a flight mass spectrometer that is used for MALDI-TOF-MS (Matrix-Assisted Laser Desorption/Ionization Time-Of-Flight Mass Spectrometry). The measurement device 20 measures the mass spectrum of proteins contained in biological samples such as blood, urine, bodily fluid, or cerebrospinal fluid.

The measurement device 20 applies laser light onto proteins and vaporizes samples to dissociate them into free ions. It then lets the protein ions to travel through the electric field in vacuum and determines the mass number based on a time for the ions to reach a detector. The mass number actually indicates the value of mass number/charge. The time of flight mass spectrometer utilizes the fact that the particles which are given the same energy by a uniform electric field have a different velocity depending on its mass. The particle with a high mass number travels at a low speed and thus takes a long time for traveling. On the other hand, the particular with a low mass number travels at a high speed and thus takes a short time for traveling. Therefore, the traveling time changes according to the mass number.

The measurement device 20 measures a mass spectrum based on the current which is detected according to the traveling time. The traveling time corresponds to the mass number and the detected current corresponds to the intensity. The mass spectrum of the proteins existing in the biological sample is thereby measured.

The output from the measurement device 20 is input to the analysis device 10 through the data I/F unit 11. The data I/F unit 11 converts analog data from the measurement device 20 into digital data, for example. The mass spectrum data which can be analyzed in the analysis device 10 is thereby input to the analysis device 10. The analysis device 10 includes a storage device such as a hard disk (not shown) to store the input mass spectrum data. The stored mass spectrum data is analyzed by the analysis unit 13. The analysis unit 13 includes a processing circuit having CPU, memory and so on and implements a prescribed analysis processing based on the input mass spectrum and outputs the analysis result.

The analysis unit 13 includes the peak position detection unit 14, the coincidence degree calculation unit 15, and the coincidence degree difference calculation unit 16. The peak position detection unit 14 detects the positions of peaks from the input mass spectrum data. Specifically, the peak position detection unit 14 detects the mass number at the top of a peak. The peak position detection unit 14 detects the peak positions for each of the input mass spectra. Normally, a plurality of peak positions are detected from one mass spectrum.

The coincidence degree calculation unit 15 calculates the coincidence degree of the peak positions which are detected from a plurality of mass spectra. The coincidence degree is a value indicating how closely coincide are the peak positions of a plurality of mass spectra. For example, if four peak positions of five mass spectra are coincide, the coincidence degree is ⅘=0.8. Thus, the coincidence degree is a value indicating in how many cases out of the entire samples are the peaks recognized for each mass number. Further, the present invention sets a window which has a certain width for the mass number to calculate the coincidence degree. If a peak position of a mass spectrum falls within the window, the coincidence degree is counted up as the peaks being coincide. This eliminates dropouts of the characteristic peaks even if there are variation factors in a mass spectrum. It is therefore suitable for use in the analysis of a biological sample with wide variations. The window width can be adjusted by a user through the input unit 12 having input devices such as a keyboard and a mouse. The peak positions which appear frequently in the target biological sample can be thereby obtained.

The coincidence degree difference calculation unit 16 calculates a difference between the two coincidence degrees which are calculated in the coincidence degree calculation unit 15. For example, the mass spectra of a plurality of samples respectively for patients and normal healthy persons are measured. Based on the coincidence degrees of the two groups, the coincidence degree difference calculation unit 16 calculates a difference of the two. It thus calculates a difference in coincidence degree between the group of patients and the group of normal healthy persons. The characteristic peaks which exhibit a difference between the patients and the normal healthy persons are thereby obtained. The display unit 17 includes a monitor such as a liquid crystal display to display analysis results. From the displayed analysis results, a user can be informed of the characteristic peaks which appear in particular disease, for example.

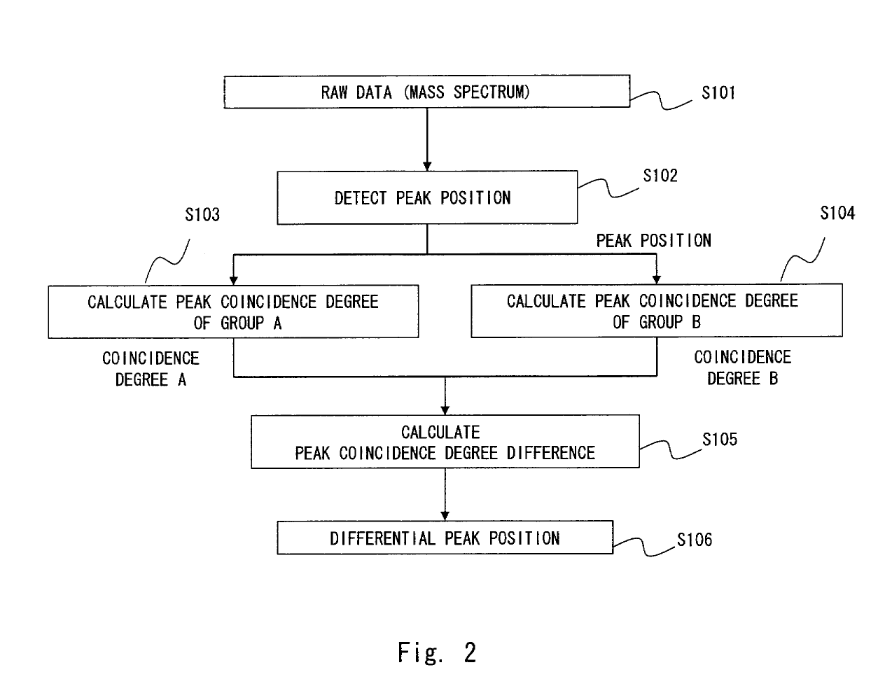

A process of the analysis method is described hereinafter with reference to FIG. 2. FIG. 2 is a flowchart showing a process of the analysis method. The mass spectra which are measured by the measurement device 20 are input to the analysis device 10 (Step S101). A plurality of mass spectra are measured respectively for patients and normal healthy persons. Specifically, the mass spectra of a plurality of patients and the mass spectra of a plurality of normal healthy persons are measured and respectively input to the analysis device 10. The group of normal healthy persons is called a group A, and the group of patients is called a group B. A user inputs whether each mass spectrum belongs either to the group A or to the group B through the input unit 12. Each of the mass spectrum data is associated with the input group and stored in the analysis device 10. Specifically, the mass spectra of normal healthy persons are stored as the group A and the mass spectra of patients are stored as the group B. Further, the name, gender, age, medical condition, or measurement condition such as a measurement date may be input through the input unit 12 and stored in association with each mass spectrum.

Then, the peak positions are detected from each mass spectrum (Step S102). This step performs the same processing on the patients and the normal healthy persons and detects the peak positions for each sample. The peak positions are stored in association with the input group. After detecting the peak positions of all the input mass spectra, a coincidence degree is calculated for each group. Firstly, the coincidence degree of the peaks is calculated for the data of the group A (Step S103). The peak positions which frequently appear in the mass spectra of the normal healthy persons are thereby obtained. Then, the coincidence degree of the peaks is calculated for the data of the group B (Step S104). The peak positions which frequently appear in the mass spectra of the patients are thereby obtained.

After that, a difference in coincidence degree is calculated based on the coincidence degrees of the group A and the group B (Step S105). This step obtains a difference between the coincidence degree of the group A and the coincidence degree of the group B. The peak position at which the difference in coincidence degree is equal to or higher than a prescribed value is determined as a differential peak (Step S106). A user inputs an arbitrary value through the input unit 12 and display the differential peaks as a table on the display unit 17. The value input by a user serves as a threshold, and the peak positions at which a difference in coincidence degree is equal to or higher than the threshold are displayed. Based on the peak positions, a user can determine whether a subject is a patient or a normal healthy person from a newly measured mass spectrum. For example, a difference in coincidence degree is large at the peak position which appears frequently for a patient and appears scarcely for a normal healthy person. A user observes whether or not the new mass spectrum has its peak at such a peak position to thereby determine whether a subject is a patient or a normal healthy person.

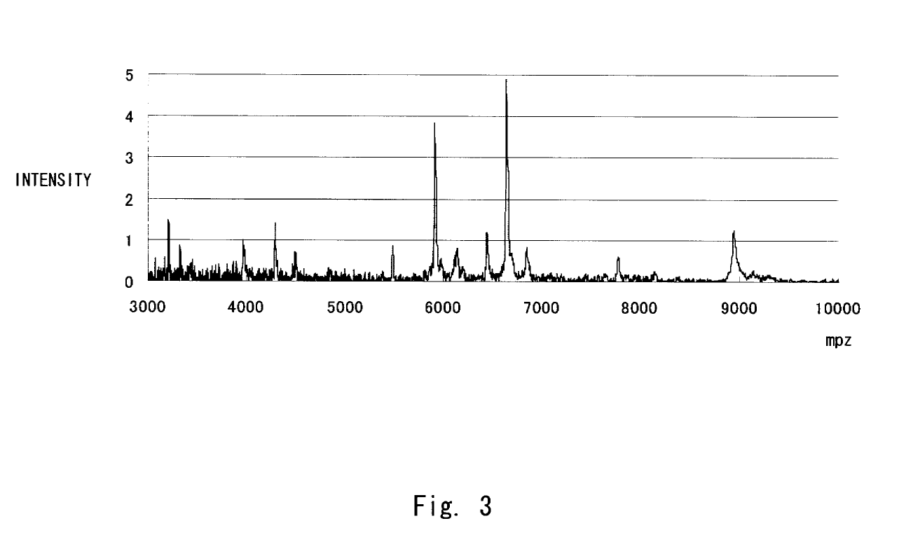

An analysis processing is described hereinafter using actual mass spectrum data and analysis data. FIG. 3 is a view showing the data measured by the measurement device 20. In FIG. 3, the horizontal axis indicates the mass number, and the vertical axis indicates the relative intensity. FIG. 3 shows an example of a measured mass spectrum. The mass number in the horizontal axis actually indicates the value of mass number/charge (mpz). The traveling time in the measurement device 20 corresponds to the mass number, and the detected current in the measuring device 20 corresponds to the intensity. The mass spectrum shown in FIG. 3 is a single mass spectrum which is measured from a single sample and it is the data of a normal healthy person. FIG. 3 shows the mass spectrum with the mass number of 3000 to 10000 (mpz), and a large number of peaks appear in this range.

The measurement is conducted on four persons serving as test subjects two times each during illness and after recovery, so that the mass spectra of total sixteen cases are obtained. The mass spectrum during illness is referred to as the data of patients, and the mass spectrum after recovery is referred to as the data of normal healthy persons. Thus, the mass spectra of eight cases each for patients and normal healthy persons are measured in this example.

The data shown in FIG. 3 is digital data, in which the intensity corresponds one-to-one with each mass number. Specifically, the intensity which corresponds to each single value of the mass number in the range from 3000 to 10000 exists as digital data. Accordingly, there are 7000 intensity values which respectively correspond to the mass numbers from 3000 to 10000.

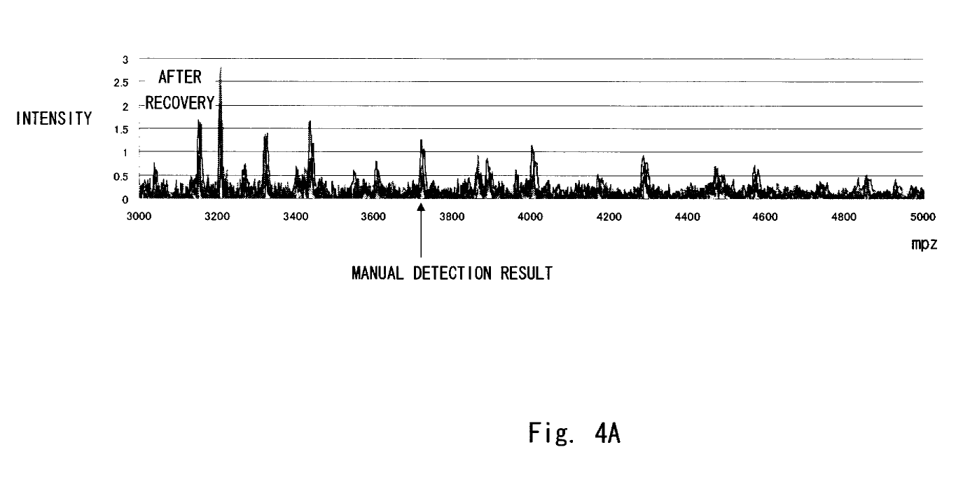

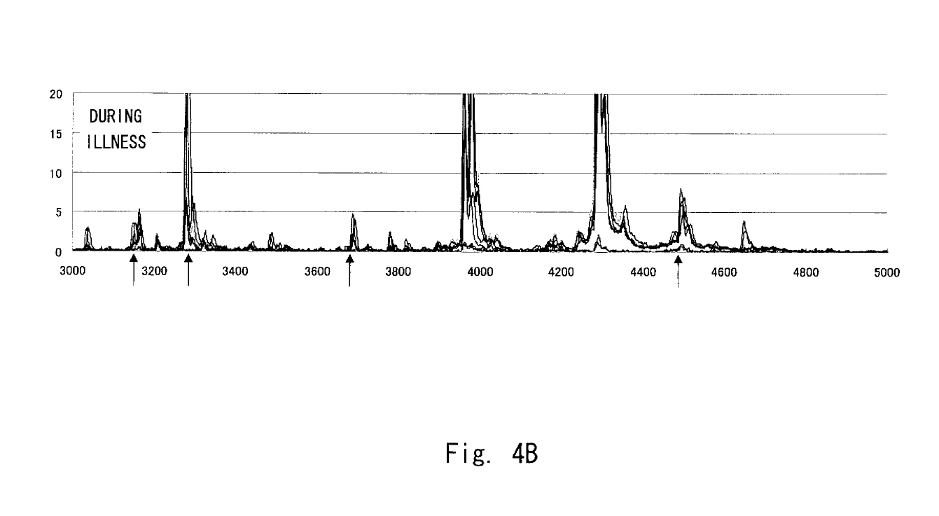

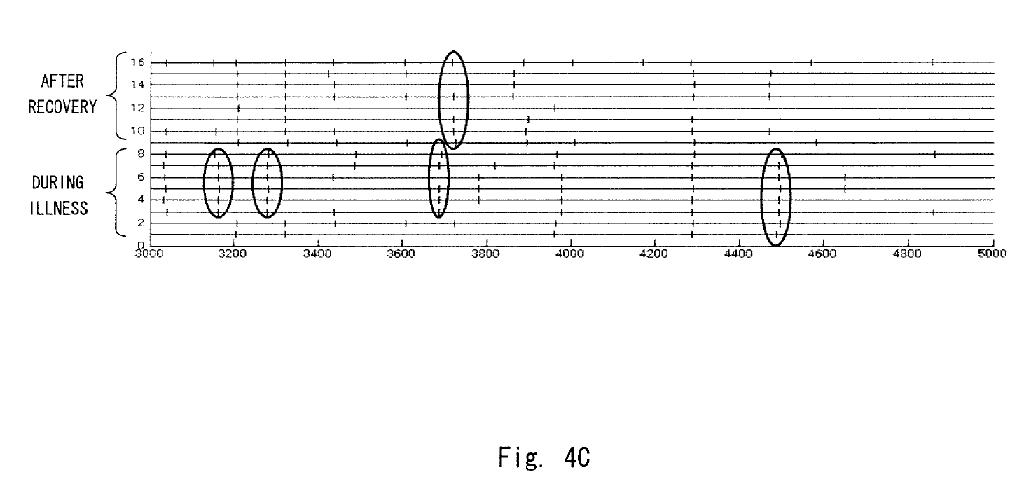

FIGS. 4A to 4C show the mass spectra measured for a plurality of samples. FIG. 4A shows the mass spectrum data of the group of normal healthy persons, and FIG. 4B shows the mass spectrum data of the group of patients. FIG. 4A shows the mass spectrum data when the patients in FIG. 4B have recovered to become normal healthy persons. In FIGS. 4A and 4B, eight mass spectra each for the patients and the normal healthy persons are shown superimposed on one another. FIG. 4C shows the peak positions detected from those mass spectrum data.

In this embodiment, the following operation is performed for the accurate detection of peak positions from a mass spectrum with much noise. Firstly, a slope of the mass spectrum is obtained by smoothing differentiation. In this example, the smoothing differentiation is performed by calculating a moving average with a smoothing point of 70. Specifically, a value is obtained by smoothing the average of the intensity values for 70 points of mass numbers. The smoothed value is differentiated to thereby obtain a slope. For example, the smoothed intensity at the mass number 4000 is an average of the intensity values at the mass numbers 3966 to 4035. The mass spectrum with much noise can be thereby smoothed.

After that, the mass number at which the smoothed intensity reaches its maximum is obtained from a change in the slope of the smoothed intensity. The point where a change in the slope turns from positive to negative exhibits a maximum value, and the mass number at this point is obtained. Further, the mass number at which the unsmoothed data reaches its greatest in the proximity of the maximum value is obtained. The proximity point is set to the same value as the smoothing point. Thus, the mass number at which the unsmoothed value reaches its greatest is obtained from the range of 70 mass numbers in the proximity of the mass number at which the smoothed value reaches its maximum. For example, if a maximum value of the smoothed intensity is reached at the mass number of 4000, the mass number at which the unsmoothed intensity reaches its greatest value is calculated from the range of the mass numbers 3966 to 4035. Further, the portion in which the greatest value of the intensity exceeds a threshold is determined as a peak, and its peak position is obtained. Thus, the mass number at which the greatest value of the intensity which exceeds the threshold exists serves as a peak position. This enables the accurate detection of a peak position in spite of the presence of much noise.

FIG. 4C shows the peak positions which are detected by the above processing. In FIG. 4C the horizontal axis indicates the mass number (mpz) and the vertical axis corresponds to each sample. The eight samples of patients correspond to 1 to 8 on the vertical axis, and the eight samples of normal healthy persons correspond to 9 to 16 on the vertical axis. On the horizontal line corresponding to each sample, a vertical marker is plotted at the mass number at which a peak is detected. Thus, the position of the marker indicates a peak position in each sample. For example, the peak is detected in the vicinity of the mass number 3200 in the samples 1 and 2. In the samples 3 to 8, on the other hand, the peak is not detected in the vicinity of the mass number 3200. The peak positions shown in FIG. 4C are detected from the sixteen samples in this embodiment.

As shown in FIG. 4C, the peak positions differ even if the patients suffer from the same disease. The peak positions also differ even if they are recovered to become normal healthy persons. In addition, the peak height or area value differs among the samples. This embodiment implements the analysis in regard to the peak position only, without regard to the peak height or area value. This enables the highly reproducible analysis without dropouts even on the biological sample with lots of variation factors.

In FIGS. 4A and 4B, the arrows below the horizontal axis designate the characteristic and differential peak of the mass spectrum which is detected manually by a skilled person. As a result of the manual detection, one characteristic and differential peak is detected from the mass spectrum after recovery, and four characteristic and differential peaks are detected from the mass spectrum during illness. Specifically, the human judgment determines that, although a peak scarcely appears in the mass spectrum during illness at the mass number indicated by the arrow in FIG. 4A showing the mass spectrum after recovery, a peak appears frequently at that mass number in the mass spectrum after recovery. On the other hand, the human judgment determines that, although a peak scarcely appears in the mass spectrum after recovery at the mass numbers indicated by the arrows in FIG. 4B showing the mass spectrum during illness, a peak appears frequently at those mass numbers in the mass spectrum during illness.

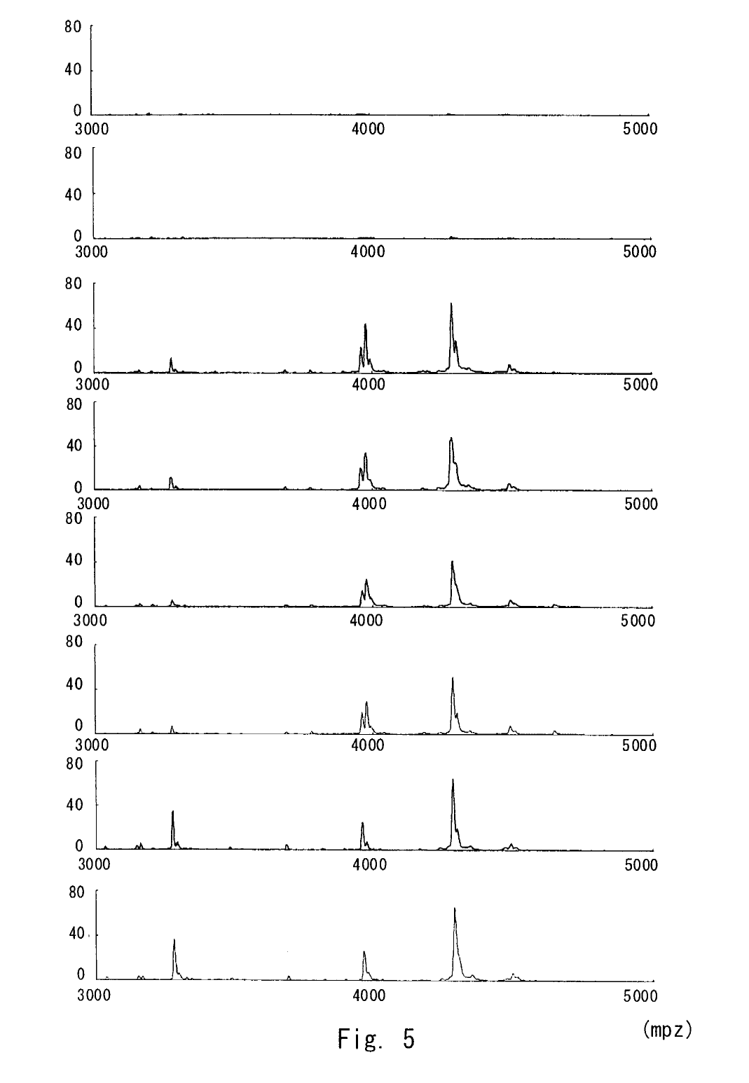

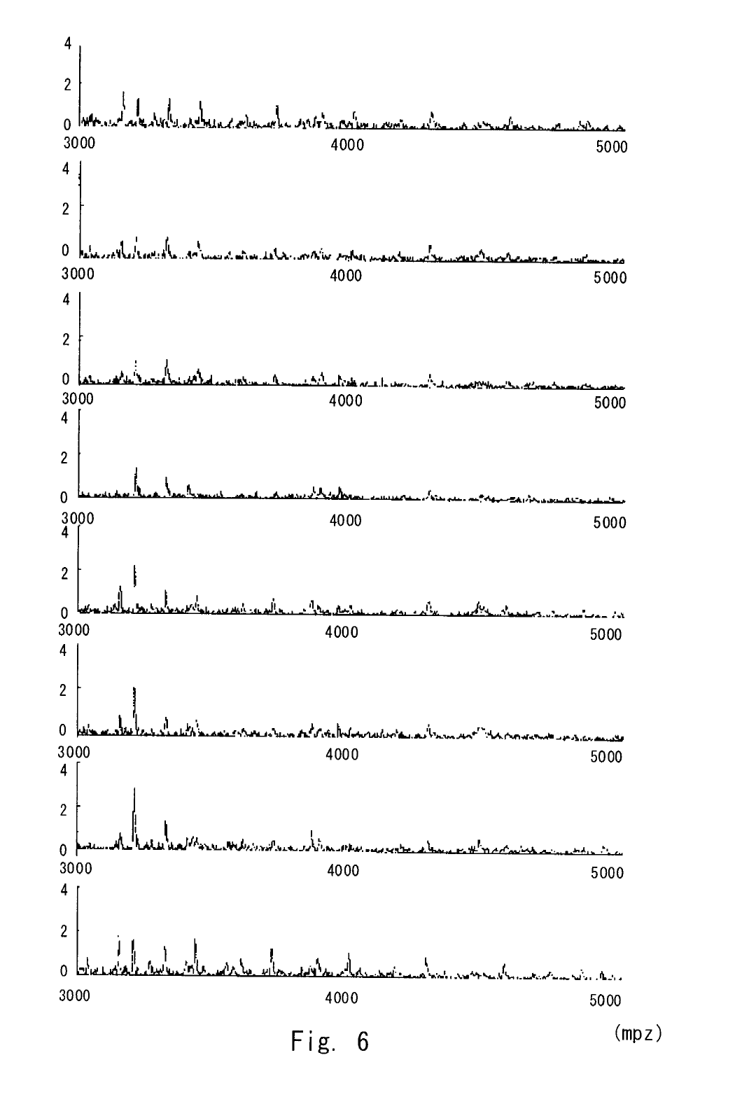

The human judgment is carried out by arranging the mass spectra in a vertical line. For example, the eight cases of mass spectra after recovery are arranged in a vertical line as shown in FIG. 5. In the same manner, the eight cases of mass spectra during illness are arranged in a vertical line as shown in FIG. 6. Further, the mass spectra after recovery and the mass spectra during illness are arranged in a vertical line. After that, a person perceptually judges the sixteen cases of mass spectra arranged in a vertical line to detect the peak which differs between after recovery and during illness. The mass number at which the peak frequently appears after recovery but scarcely appears during illness and the mass number at which the peak scarcely appears after recovery but frequently appears during illness are detected as the characteristic and differential peak positions. The peak positions are used to determine whether a subject is either a patient or a normal healthy person.

When the mass spectra shown in FIGS. 5 and 6 are arranged in a vertical line and a person makes a perceptual judgment thereon, a large number of peaks exist in each mass spectrum and therefore the analysis is complicated. Accordingly, some characteristic and differential peak position can be missed. Further, due to being a biological sample, the mass spectrum can vary depending on an individual difference, a change in health condition, and so on. In addition, the presence of atom isotope, the coexistence of a plurality of biochemical substances, the performance of an analysis device, the resolution and so on complicate the analysis. An increase in the number of samples for the purpose of improving the statistical accuracy causes not only a decrease in analysis efficiency but also a failure in highly reproducible analysis in the human perceptual judgment.

The present invention implements the automatic detection of peaks by prescribed processing, thereby providing highly reproducible analysis without dropouts even on the biological sample with lots of variation factors. Further, the present invention implements the analysis in regard to the peak position only, without regard to the peak height or area value, thus being suitable for the biological samples with wide variations such as changes in health condition or individual differences. Furthermore, the present invention enables the reduction of an analysis time even if the number of samples is increased in order to improve the statistical accuracy.

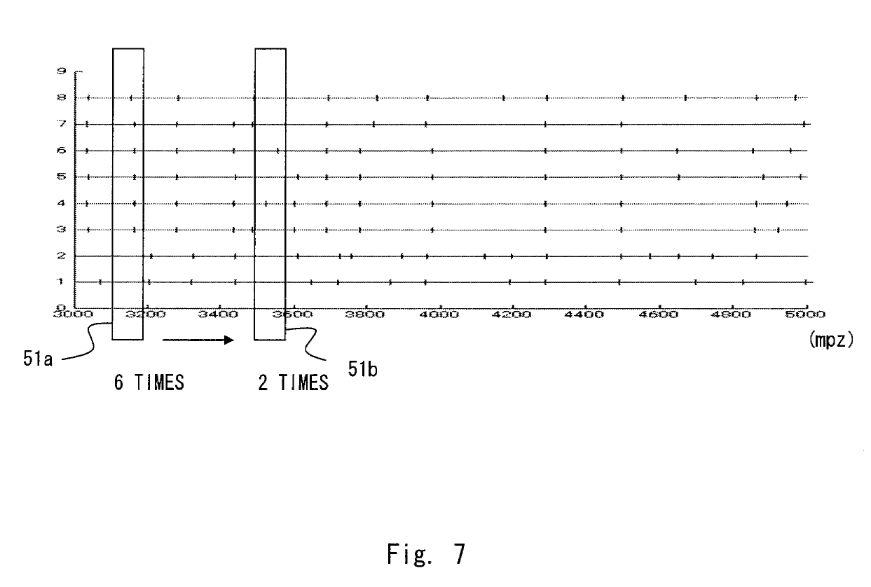

The step of calculating the coincidence degree is described hereinafter with reference to FIG. 7. FIG. 7 is a view showing the peak positions of the mass spectrum for samples during illness. In FIG. 7, just like FIG. 4C, the horizontal axis indicates the mass number (mpz) and the vertical axis corresponds to each sample. The eight samples of patients correspond to 1 to 8 on the vertical axis. On the horizontal line corresponding to each sample, a vertical marker is plotted at the mass number at which a peak is detected. Thus, the position of the marker indicates a peak position in each sample.

The peak coincidence degree is a value indicating how closely coincide are the peak positions of a plurality of mass spectra. Because the number of samples during illness is eight in this example, if the peak appears at the same mass number in all of the eight mass spectra, the coincidence degree at that mass number is 8/8=1. On the other hand, if no peak appears at the same mass number in all of the eight mass spectra, the coincidence degree at that mass number is 0. At the mass number at which the peak appears in one out of the eight mass spectra, the coincidence degree at that mass number is ⅛=0.125. The peak coincidence degree is calculated for each mass number.

The present invention calculates the coincidence degree by setting a window 51 having a certain width for the mass number in consideration of variation factors of a mass spectrum. Specifically, in the target mass spectrum, the coincidence degree is calculated based on the number of peaks which fall within the width of the window. For example, referring to the window 51a shown in FIG. 7, six peaks corresponding to the samples 3 to 8 are contained in the window, though they are not at exactly the same mass number. The coincidence degree is calculated based on the number of peaks contained in the window. The mass number at the six peak positions may be exactly the same or different from each other. Referring then to the window 51b shown in FIG. 7, the peaks at different mass numbers are detected from the samples 4 and 6, which are contained in the window 51b. Thus, the coincidence degree is counted based on the two peaks. In this exemplary analysis, a window width is 10 mpz, and the window having the width of 10 mpz is scanned for the mass number, thereby counting the number of the peaks which are contained in the window. Specifically, the window having the width of 10 mpz is shifted by 1 mpz each, and the number of peak positions contained in the window is counted. Then, the coincidence degree at each mass number is calculated based on the number of peaks contained in the window. In this way, calculating the coincidence degree based on the number of peaks contained in the window enables the analysis without dropouts even on a biological sample with lots of variation factors.

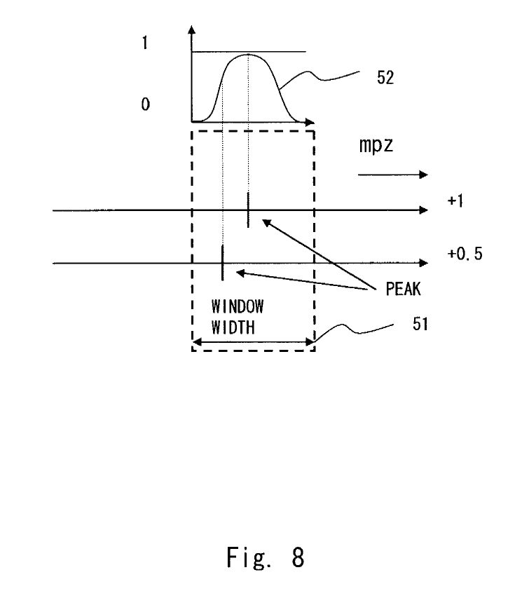

As described above, the coincidence degree is calculated based on the number of peaks which fall within the window width. Further, the present invention sets the shape of a window to a cosine curve and changes the number of peaks contained in the window according to the position within the window. Specifically, it assigns weights to the peak positions contained in the window width according to their positions. The function for the weighting is a cosign function. The shape of the window is described hereinafter with reference to FIG. 8. FIG. 8 is a view showing the relationship between a window shape and a peak position. FIG. 8 shows two samples for purposes of illustration.

As shown in FIG. 8, a window shape 52 is a cosign curve. Accordingly, a value reaches its maximum, i.e. 1, at the center of the window 51, decreases towards the outer sides of the window 51 and eventually reaches 0 at the both ends of the window 51. The values corresponding to the window shape 52 are added up for all samples and divided by the number of samples. Based on this value, the coincidence degree of peaks is calculated. For example, it is assumed in the two samples shown in FIG. 8 that the peak positions are out of alignment from each other in such a place as falling within the window. Therefore, if the center of the window is scanned at one peak position, the other peak position point is deviated from the center. This value is 0.5. FIG. 8 shows the configuration when scanning is carried out in such a way that the center of the window falls upon one peak position. At this time, the value of the window shape 52 which corresponds to the other peak position is 0.5.

In the configuration shown in FIG. 8, the window shape 52 is such that one is 1 and the other is 0.5. The coincidence degree is obtained based on a result of dividing a sum of the values of the window shape 52 for all samples by the number of samples. In the configuration shown in FIG. 8, the number of peaks contained in the window is 1+0.5=1.5. On the other hand, when the window is scanned and thereby the center of the window falls upon the other peak position, the number of peaks contained in the window is 0.5+1=1.5. In this way, the number of peaks contained in the window is calculated in consideration of the window shape 52. Then, the window position is scanned to thereby calculate the number of peaks contained in the window for the entire mass spectrum. As a result, the number of peaks contained in the window is a function of the mass number. From a change in the slope of the number of peaks contained in the window, the mass number at which a maximum value is reached is obtained. The point where a change in the slope turns from positive to negative is a maximum value, and the mass number at this point is obtained. The number of peaks at the mass number at which a maximum value is reached serves as the coincidence degree of peaks. Because the window has a certain width for the mass number, the number of peaks contained in the window is larger in the vicinity of the maximum value to be close to the value at the maximum value. By obtaining the maximum value for the number of detected peak positions contained in the window and further calculating the peak coincidence degree for the maximum value, the coincidence degree of peaks can be calculated accurately. This enables the obtainment of the peak positions which appear frequency for each group.

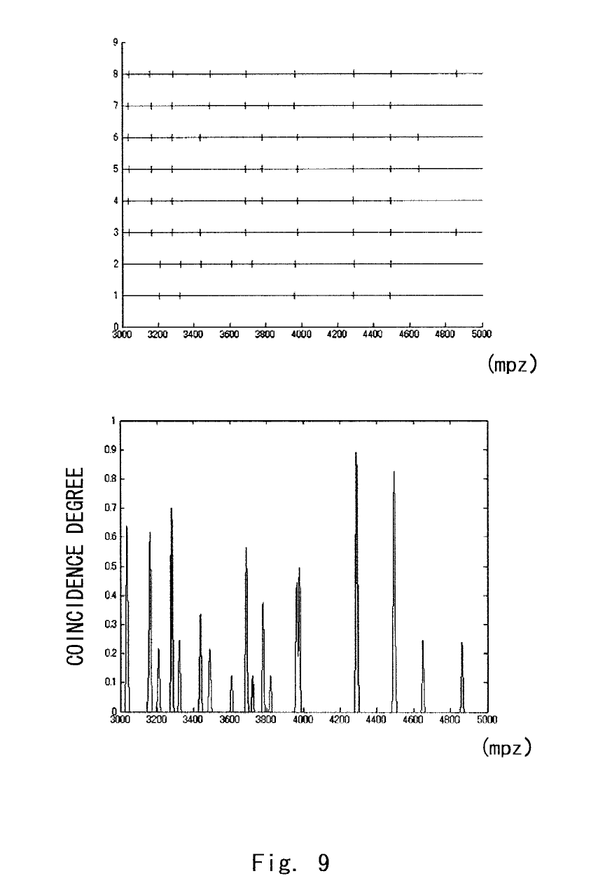

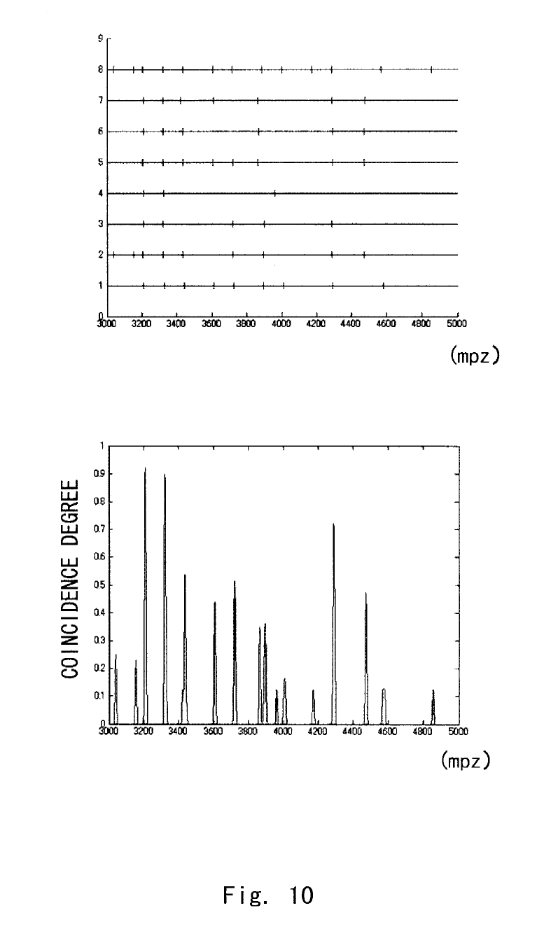

FIGS. 9 and 10 show the peak positions and the peak coincidence degree which are obtained as above. FIG. 9 is a graph showing the results of analysis on the samples during illness. FIG. 10 is a graph showing the results of analysis on the samples after recovery. In FIGS. 9 and 10, the upper graph shows the peak positions, and the lower graph shows the peak coincidence degree, respectively. In the graph showing the peak coincidence degree, the horizontal axis indicates the mass number, and the vertical axis indicates the peak coincidence degree. The coincidence degree of the peak positions is calculated for each of two groups of biological samples.

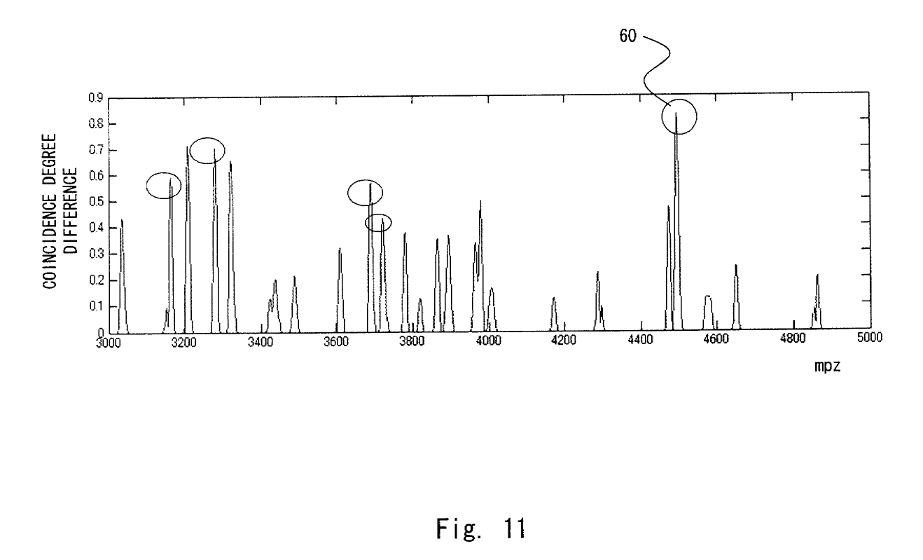

The step of calculating a difference between the coincidence degree after recovery and the coincidence degree during illness is described hereinafter with reference to FIG. 11. FIG. 11 is a view showing a difference in the calculated coincidence degree. It illustrates an absolute value of a result of subtracting the coincidence degree during illness from the coincidence degree after recovery. As the difference in coincidence degree is larger, a peak appears frequently in either one of after recovery or during illness and scarcely appears in the other one.

The calculation of a difference in peak coincidence degree enables the obtainment of characteristic and differential peak positions. At the mass number at which the peak appears frequently after recovery and scarcely during illness, a difference in coincidence degree is large. Further, at the mass number at which the peak appears frequently during illness and scarcely after recovery, a difference in coincidence degree is large. The peak which appears at such a mass number is a characteristic and differential peak. On the other hand, at the mass number at which the peak appears frequently both during illness and after recovery, a difference in coincidence degree is small. Because a peak appears in most samples at this mass number, the peak which appears in the vicinity of this mass number is a non-differential peak. At the mass number at which the peak appears scarcely both during illness and after recovery, a difference in coincidence degree is large. Because a peak does not appear in most samples at this mass number, the peak which appears in the vicinity of this mass number, if any, is considered due to variation factors. As a difference in peak coincidence degree is larger, a difference in the frequency that a peak appears is larger between patients and normal healthy persons. Accordingly, as a difference in peak coincidence degree is larger, a characteristic and differential peak is more likely to exist at the mass number.

FIG. 11 shows a manual detection result 60 for comparison. The peak surrounded by the manual detection result 60 is determined by a person as a characteristic and differential peak. The comparison shows that the present invention enables the detection of a plurality of characteristic and differential peaks in addition to those determined as characteristic and differential peaks by a person. Further, it shows that at some peak position which is not detected by the manual detection result 60, a difference in coincidence degree is larger than that at the peak position detected by the manual detection result 60. As described above, the characteristic and differential peak can be analyzed without dropouts by calculating a difference in the peak coincidence degree.

Table 1 shows the analysis results of peak positions analyzed according to the present invention.

TABLE 1

| | AUTOMATIC | |
|---|---|---|
| DIFFERENCE IN | DETECTION | MANUAL DETENTION |
| COINCIDENCE DEGREE | RESULT | RESULT |
| 0.827 | 4495 | 4489 |
| 0.713 | 3208 | |
| 0.701 | 3279 | 3276 |
| 0.654 | 3322 | |
| 0.593 | 3163 | 3164 |
| 0.566 | 3689 | 3687 |
| 0.495 | 3979 | |
| 0.432 | 3035 | |
| 0.427 | 3721 | 3723 |

Table 1 shows the characteristic and differential peak positions which are detected by the analysis method according to the present invention as the automatic detection result. The analysis result may be displayed on the display unit 17 as a table. For example, an arbitrary value may be input through the input unit 12, and the peak positions having a difference in coincidence degree which is equal to or higher than the input value may be displayed on the display unit 17. In Table 1, the peak positions are displayed from the top in descending order of a difference in coincidence degree. For comparison, Table 1 also shows the characteristic and differential peak positions which are detected by the manual detection by a person.

As shown in Table 1, the manual detection sometimes fails to detect the mass number at which a difference in coincidence degree is large. The present invention obtains the characteristic and differential peak positions as described above, thereby achieving the accurate analysis without dropouts. Further, even when the number of samples is increased in order to reduce statistical errors, the present invention can perform the analysis in a significantly shorter time than the manual detection. As a result of the accurate analysis without dropouts, the peak position which appears frequently in a specific disease can be identified accurately. Using the peak positions, it is possible to accurately determine whether or not another target person suffers from the specific disease.

Further, the present invention allows a user to input various settings through the input unit 12. For example, the window width may be adjusted according to a sample to be analyzed or disease. A smoothing point or a threshold in the peak position detection step may be varied. Further, the window shape may be set arbitrarily and weights may be assigned with a function different from a cosign function. Allowing a user to input these settings enables the accurate analysis as appropriate according to various diseases. Furthermore, the scanning pitch of the window is not limited to 1 mpz. More accurate analysis would be enabled by smaller scanning pitch, and shorter analysis time would be enabled by larger scanning pitch. The scanning pitch or the window width is not limited to an integer but may be a decimal.

The above-described analysis process or set values are given by way of illustration only, and the present invention is not limited to the above embodiments. Although the intensity data exists for each 1 mass number in the mass spectrum in the above description, the intensity data in practice exists for each mass number in accordance with the resolution of the measurement device 20. If the resolution of the measurement device 20 is 0.1, the intensity data exists for each 0.1 mass number. In such a case, the peak position is detected at the resolution of 0.1. The analysis according to the present invention is suitable for use on the mass spectrum which is obtained by ionizing proteins in a biological sample by SELDI or MALDI, for example.

The present invention extracts the information only regarding peak positions from a mass spectrum and carries out the analysis based on the peak positions. This enables the highly reproducible and accurate analysis without dropouts even if the peak height or area varies by a variety of variation factors. Further, the present invention calculates the number of peak positions of a plurality of biological samples which is contained in the window having a certain width for the mass number. This enables the accurate analysis without dropouts even if the peak positions are not aligned due to variation factors such as the presence of isotope.

The mass spectrum analysis device and the mass spectrum analysis method according to the present invention may be implemented not only by a normal personal computer (PC) but also by a work station, a general purpose machine, a FA computer, or a combination of those. These components, however, are given by way of illustration only, and not all the components are fundamental components for the present invention. Further, the analysis device is not necessarily physically integrated, and it is possible to perform parallel processing by a plurality of terminals.

### INDUSTRIAL APPLICABILITY

The present invention may be applied to a mass spectrum analysis device, a mass spectrum analysis method, and a mass spectrum analysis program for analyzing the mass spectrum measured for samples.

1. A mass spectrum analysis device for analyzing mass spectrum measured for a plurality of samples, comprising:
peak position detection means for detecting a peak position where the mass spectrum is at its peak; and
coincidence degree calculation means for calculating a coincidence degree of peaks according to the number of peak positions detected in a plurality of mass spectra that is contained in a window having a width for a mass number.

2. The mass spectrum analysis device according to claim 1, wherein weights are assigned to the number of peaks according to a position of the window.

3. The mass spectrum analysis device according to claim 1, wherein
the plurality of mass spectra are measured for each of two different groups of samples, and
the device further comprises coincidence degree difference calculation means for calculating a difference in coincidence degree between the two different groups.

4. A mass spectrum analysis method for analyzing mass spectrum measured for a plurality of samples, comprising:
a peak position detection step for detecting a peak position where the mass spectrum is at its peak; and
a coincidence degree calculation step for calculating a coincidence degree of peaks according to the number of peak positions detected in a plurality of mass spectra that is contained in a window having a width for a mass number.

5. The mass spectrum analysis method according to claim 4, wherein weights are assigned to the number of peaks according to a position of the window.

6. The mass spectrum analysis method according to claim 4, wherein
the plurality of mass spectra are measured for each of two different groups of samples, and
the method further comprises a coincidence degree difference calculation step for calculating a difference in coincidence degree between the two different groups.

7. A mass spectrum analysis program for analyzing mass spectrum measured for a plurality of samples, causing a computer to implement a method comprising:
a peak position detection step for detecting a peak position where the mass spectrum is at its peak; and
a coincidence degree calculation step for calculating a coincidence degree of peaks according to the number of peak positions detected in a plurality of mass spectra that is contained in a window having a width for a mass number.

8. The mass spectrum analysis program according to claim 7, wherein weights are assigned to the number of peaks according to a position of the window.

9. The mass spectrum analysis program according to claim 7, wherein
the plurality of mass spectra are measured for each of two different groups of samples, and
the method further comprises a coincidence degree difference calculation step for calculating a difference in coincidence degree between the two different groups.
